(19) United States
(12) Patent Application Publication
(10) Pub. No.: US 2010/0242994 A1
(43) Pub. Date: Sep. 30, 2010

(54) DEVICE AND METHOD FOR COLLECTING WASTE WATER FROM TURBINE ENGINE WASHING

(75) Inventors: Henrik Amcoff, Nacka (SE); Helena Nyberg, Stockholm (SE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: Gas Turbine Efficiency Sweden AB, Jarfalla (SE)

(21) Appl. No.: 12/643,462

(22) Filed: Dec. 21, 2009

Related U.S. Application Data
(60) Provisional application No. 61/164,524, filed on Mar. 30, 2009.

(51) Int. Cl. B08B 7/04

(52) U.S. Cl. 134/10; 134/104.2

(57) ABSTRACT

An apparatus is provided for collecting waste water from cleaning operations performed on aircraft turbine engines. The apparatus comprises a frame structure. On the frame structure a support arm is pivotally mounted. An actuator arm is arranged to raise and lower the support arm between an essentially horizontal transport position to an operative position forming an angle in the range of more than 0° to 90° or less with respect to the horizontal. A liquid separation device is pivotally attached to the support arm so as to be movable around both a horizontal and a vertical axis.

### CROSS REFERENCE TO RELATED APPLICATIONS

This Application claims priority to U.S. Provisional Patent Application No. 61/164,524, entitled “Collector,” filed on Mar. 30, 2009, the contents of which are incorporated herein in its entirety.

### TECHNICAL FIELD

The present disclosure generally relates to the field of washing aircraft engines, particularly using washing liquids such as water and detergent or water only, and more specifically to a system and devices for collecting the waste water from engine washing operations and a mobile vehicle comprising such a system.

### BACKGROUND

A gas turbine engine installed as an aircraft engine comprises a compressor for compressing ambient air, a combustor for burning fuel together with the compressed air, and a turbine for driving the compressor. The expanding combustion gases drive the turbine and also result in thrust used for propelling the aircraft.

Air breathing machines, such as jet engines, consume large quantities of air. Air contains foreign particles in the form of aerosols or larger particles which then enter the engine with the air stream. The majority of the particles may follow the gas path through the engine and exit with the exhaust gases. However, there are particles with properties that cause adherence to components in the engine's gas path, thus changing the aerodynamic properties of the engine and, more particularly, reducing engine performance. Typical contaminants found in the aviation environment may include, for example, pollen, insects, engine exhaust, leaking engine oil, hydrocarbons coming from industrial activities, salt coming from nearby sea, chemicals coming from aircraft de-icing, and airport ground material such as dust.

The contaminants adhering to components in the engine gas path cause fouling of the engine. One consequence of gas path fouling is an engine operating less efficiently. With the reduction in efficiency follows that the engine is less economic to operate and has higher emissions. Fouling may typically result in more fuel being burnt to achieve the same thrust as for a clean engine. Further, an environmental drawback from the higher fuel consumption is in the form of increased carbon dioxide emissions. In addition, more fuel being burnt results in higher temperatures in the engine's combustor. With this follows high temperature exposure to engine hot section components. The higher temperature exposures may typically shorten the life time of the engine. The higher firing temperature may result in increased formation of NOx, which is yet another environmental drawback. In summary, the operator of a fouled engine suffers from reduced engine lifetime, unfavourable operating economics, and higher emissions. The airline operators have therefore a strong incentive to keep the engine clean.

It has been found that a reasonable way to combat fouling is to wash the engine. Washing may be achieved by directing a water jet from a hose towards the engine inlet. However, this method has limited success due to the simple nature of the process. An alternative method involves pumping wash liquid through a manifold with special nozzles directed towards the engine inlet face. The manifold may be temporarily installed on the engine cowl or on the engine shaft bullet during the wash operation. Simultaneously with spraying the washing liquid towards the engine inlet, the engine shaft may be cranked by the use of its starter motor. The shaft rotation enhances the wash result by the mechanical movements. The shaft rotation allows the wash liquid to move over greater surface area as well as enhances liquid penetration into the interior of the engine. The method is proven successful on most gas turbine jet engines types such as turbojets, turboprop, turboshaft, and mixed or un-mixed turbofan engines.

A proper wash operation of a gas turbine engine can be confirmed by an observation that the wash liquid exits the engine at the engine outlet. At the engine outlet the wash liquid has become a waste liquid. The waste liquid may leave the engine outlet as a stream of liquid pouring to the ground. Alternatively, the waste liquid may be carried with the air stream as fine droplets where the air stream is the result of the rotation of the engine shaft. This air borne liquid may be carried a significant distance before falling to the ground. It is shown from actual wash operations that waste liquid will be spread on a large surface area, typically more than 20 meters downstream of the engine outlet. It is not desirable to spread waste liquid on the ground.

The waste liquid exiting the engine at washing may include the wash liquid entering the engine together with released fouling material, combustion solids, compressor and turbine coating material, and oil and fat products. This waste liquid may be hazardous. As an example, analysis of water collected from actual turbine engine washing operations was shown to contain cadmium. The cadmium comes from compressor blade coating material released during washing operation. Cadmium is environmentally very sensitive and can not be allowed to be disposed to the effluent. This waste liquid would have to undergo treatment for separation of hazardous components before being disposed in a sewer.

Gas turbine aircraft engines may be of different types, such as turbojets, turboprop, turbo-shaft, and mixed or un-mixed turbofan engines. These engines cover a large performance range and may comprise of different design details by different manufactures. Aircrafts types for a defined service may be offered from different aircraft manufacturers, thus the design of the aircraft and its engines may vary. Further, the aircraft manufacturer may offer different engine options for the same aircraft type. The large combined possibility of engines on aircraft types and from different aircraft manufacturers results in a practical problem in designing a system for collecting and treating of waste wash liquid that is generally applicable to most winged aircraft.

Collecting waste water from engine washing may be accomplished by hanging canvas-like collectors under the engine nacelle. However, any operation resulting in a component or material being hooked on to an engine has the disadvantage that it may be subject to engine damage.

Thus, it is desirable to provide an improved method and apparatus for collecting and treating waste liquid exiting the engine from an engine washing operation for numerous aircraft types, including those having an exhaust located in difficult to reach positions.

### SUMMARY

In one embodiment, an apparatus for collecting waste water from cleaning operations performed on aircraft turbine engines is provided.

In another embodiment, a method of collecting liquid emanating from the exhaust of an aircraft turbine engine during a washing operation, where the exhaust is located on the air craft at a position that is not easily accessible, is provided.

Further scope of applicability of the present disclosure will become apparent from the detailed description given hereinafter and the accompanying drawings which are given by way of illustration only, and thus not to be considered limiting.

### BRIEF DESCRIPTION OF THE DRAWINGS

Embodiments will now be described in greater detail with reference to the accompanying drawings, in which:

FIG. 1 is cross sectional representation of an un-mixed turbofan gas turbine engine;

FIG. 2 illustrates the exiting of waste liquid from the un-mixed turbofan engine during washing thereof;

FIG. 3a illustrates a waste liquid collecting device;

FIG. 3b is a schematic illustration of the working principle of a droplet separator;

FIG. 4 illustrates one embodiment of a system according to the present disclosure;

FIGS. 5a-c illustrate the design of a liquid separator frame;

FIG. 6 illustrates mechanism for tilting the liquid separator frame;

FIGS. 7a-b provides details of the mechanism for side-ways movement of the liquid separator frame;

FIG. 8 illustrates the apparatus according to the disclosure in use during cleaning of a helicopter turbine having a rear exhaust;

FIG. 9 illustrates the apparatus according to the disclosure in use during cleaning of a helicopter turbine having a side exhaust;

FIG. 10 illustrates the apparatus according to the disclosure in use during cleaning of a turboprop aircraft turbine having an exhaust facing downwards;

FIG. 11 illustrates different modes of operation of the apparatus according to the disclosure; and

FIG. 12 illustrates a flowchart for a method of collecting liquid emanating from the exhaust of an aircraft turbine engine during a washing operation, according to an embodiment.

### DESCRIPTION OF PREFERRED EMBODIMENTS

The disclosed apparatus and method may be utilized on several engine types, such as but not limited to turboshaft, turboprop, turbojet and mixed/un-mixed multi shaft turbofan engines, but in particular it is directed for use with helicopters and turboprop powered aircraft. The disclosed apparatus and method may also be utilized for cleaning of fighters.

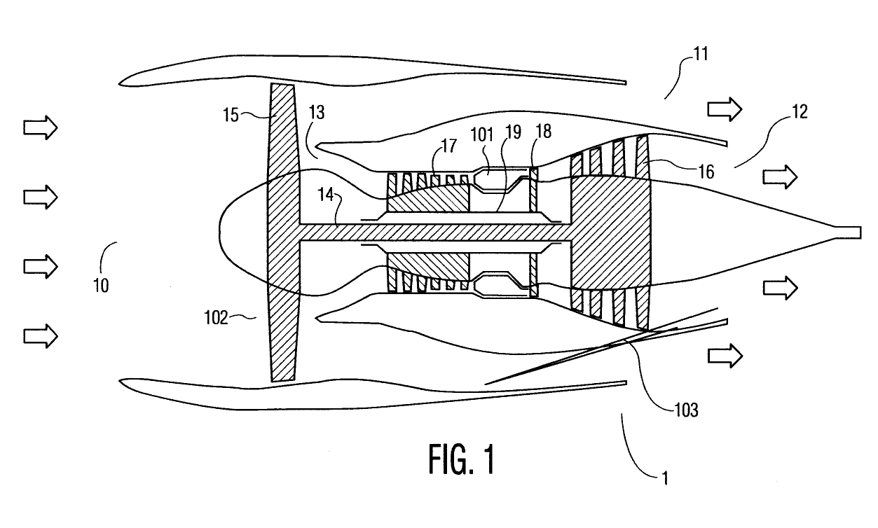

FIG. 1 shows a cross section of an un-mixed turbofan engine, which may be found on, for example, large aircraft in passenger service. Engine 1 includes a fan section 102 and a core engine section 103. Air flows are indicated by arrows. Engine 1 includes an inlet 10, at which air enters the engine 1. The air flow is driven by fan 15. A portion of the inlet air exits at outlet 11. The remaining portion of the inlet air enters into the core engine section 103 at inlet 13. The air to the core engine section 103 is compressed by compressor 17. The compressed air together with fuel (not shown) is combusted in combustor 101, resulting in pressurized hot combustion gases. The pressurized hot combustion gases expand towards core engine outlet 12. The expansion is done in two stages. In a first stage, the combustion gases expand into an intermediate pressure while driving turbine 18. In a second stage, the combustion gases expand towards ambient pressure while driving turbine 16. Turbine 16 is driving fan 15 via a shaft 14. Turbine 18 is driving compressor 17 via a second shaft 19, where the second shaft 19 is in form of a coaxial to the shaft 14.

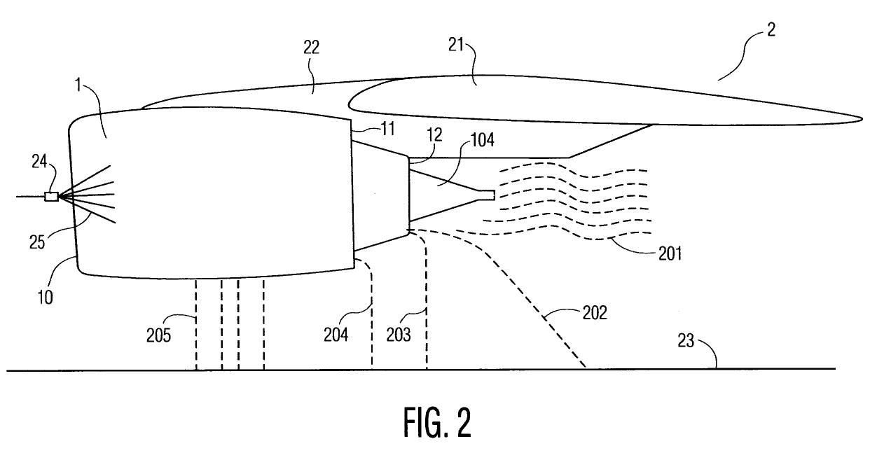

FIG. 2 illustrates the engine 1, described in FIG. 1, during an engine wash operation. Similar parts are shown with the same reference numbers as in FIG. 1. FIG. 2. provides a side view of engine 1. Engine 1 is an “under-wing engine” installed under wing 21 with support 22, where wing 21 is part of aircraft 2. A manifold (not shown) for injecting washing liquid may be installed in the engine inlet 10 of engine 1. The manifold may be configured to hold a plurality of nozzles 24 in position upstream of the fan of engine 1. A wash pump unit (not shown) may be configured to pump a washing liquid through nozzles 24, thereby forming sprays 25 directed toward the fan and core engine air inlets of engine 1. The liquid cleans the gas paths of the fan and the core engine. To enhance the cleaning effect, the engine shafts may be cranked by the use of the engine's starter motor. Cranking of the shafts enables the liquid to move around inside the engine to achieve an enhanced cleaning effect. The rotation of the shafts results in an airflow carrying the liquid towards the engine outlet, hence liquid will exit the engine at the rear. Liquid exiting the engine is waste liquid.

With respect to FIG. 2, liquid may exit the engine in at least five different ways. The first liquid category, stream 201, may exit the core engine outlet 12 as airborne droplets. The droplets that make up stream 201 are generated inside the engine by the motion of the compressor and turbines blades. Stream 201 includes droplets with a large size range, where the different droplet sizes have different characteristics. The smallest droplets, i.e. droplets less than 30 microns, may typically quickly evaporate in the ambient air due to their small size. Droplets less than 30 microns are therefore not of substantial concern in the waste water collection process for reason of the evaporation and because they represent only a small volume of the waste liquid. The largest droplets in stream 201 are droplets in the size of raindrops, for example, 2000 microns in size. These droplets are heavy and may likely not evaporate but instead fall to the ground by gravity. Droplets greater than 30 microns but less than 2000 microns may likely be carried with the air stream and fall by gravity to ground 23 typically up to 20 meters behind the engine outlet.

The second liquid category, stream 202, may include strings of liquid and other large chunks of liquid. Stream 202 may typically quickly fall to the ground 23 by gravity. The third liquid category, stream 203, may include liquid pouring as a solid or near solid stream out of the core engine outlet 12. This liquid pours typically vertically or near vertically to ground 23. The fourth liquid category, stream 204, may include liquid pouring out from the fan duct outlet 11. This liquid may fall basically vertically or near vertically to ground 23. The fifth liquid category, stream 205, may include liquid dropping or pouring from the bottom of the engine nacelle. The source for this liquid may be, for example, the combustor drain valves being open.

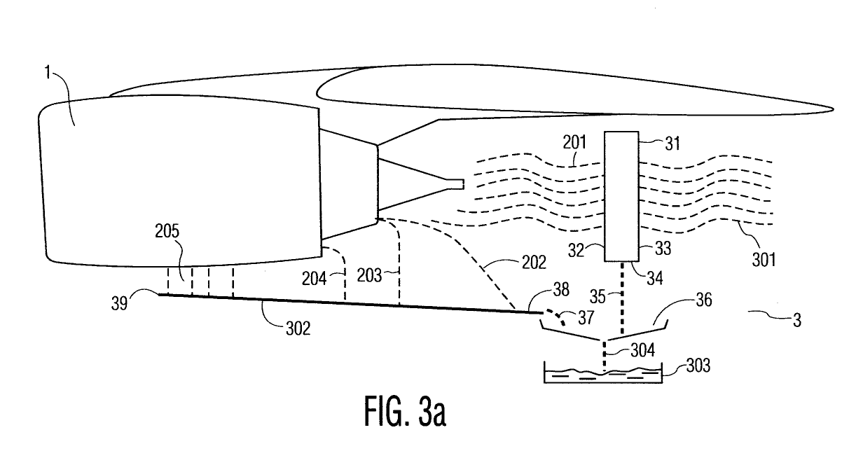

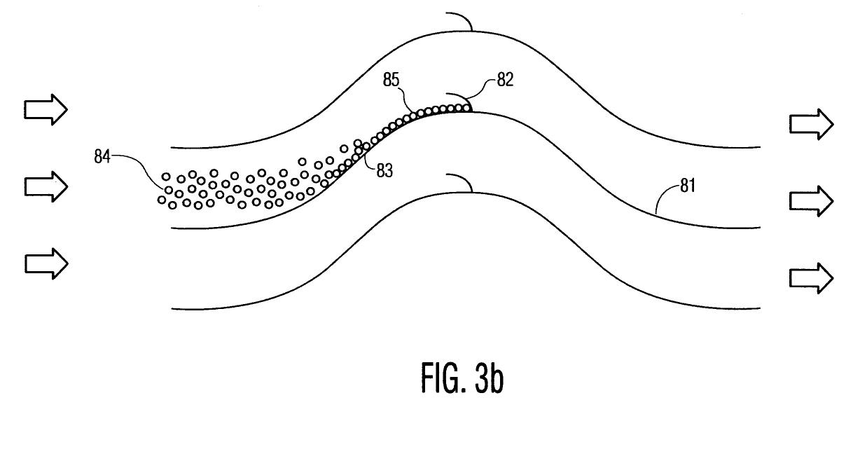

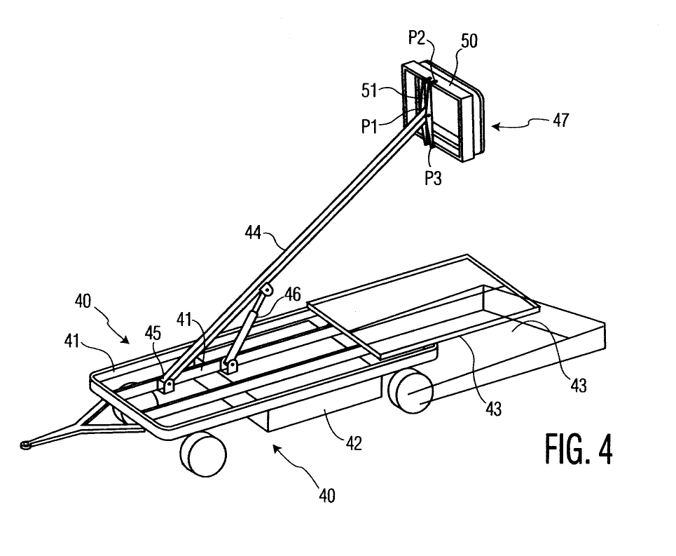

FIG. 3a provides a side view of engine 1 and collection of waste liquid during washing, which for purposes of illustration and without limitation, is of the type in an exemplary embodiment according to a system disclosed in WO 2005/121509, the contents of which are incorporated herein in its entirety. Similar parts are shown with the same reference numbers as FIG. 2. Collector 3 includes a liquid separation device 31, a trough 36, and a chute 302. Liquid exiting the engine 1 as stream 201 is separated from the carrier air in liquid separation device 31. Liquid exiting the engine as stream 202, stream 203, stream 204, and stream 205 are collected by chute 302. The liquid emanating from liquid separation device 31 and chute 302 is collected in trough 36.

Liquid separation device 31 has an inlet face 32 directed towards air stream 201 and an outlet face 33 opposite inlet face 32. Stream 201 enters the liquid separation device 31 at inlet face 32 and exits the liquid separation device at outlet face 33. The liquid is trapped in the liquid separation device 31 so that stream 301 is essentially free from liquid after passing through the liquid separation device 31. The liquid separation device 31 may include vertically arranged separator profiles (see FIG. 3b) in a frame. The separator profiles may be configured to deflect the air stream. As a result, the momentum of the droplets causes them to impinge onto the profile surface. The droplets coalesce together and form a liquid film. The influence of gravity on the film causes the liquid to drain to the bottom of the profile and exit the liquid separation device at face 34 as stream 35. Waste liquid stream 35 falls by gravity into trough 36.

FIG. 3a shows chute 302 installed under engine 1. Chute 302 is configured to collect streams 202, 203, 204, and 205, as shown in FIG. 3a. Chute 302 has a front end 39 and a rear end 38, where front end 39 is positioned vertically higher than rear end 38. As front end 39 is higher than rear end 38, the chute 302 is inclined. The inclination of chute 302 allows for liquid in the chute 302 to flow from the left to the right as shown in FIG. 3a. Rear end 38 is positioned above trough 36 so that liquid will pour out of chute 302 into trough 36 as stream 37. According to an alternative embodiment, chute 302 may be incorporated in trough 36 and tank 303, thereby forming one single unit. Streams 35 and 37 that fall into trough 36 may then fall by gravity as stream 304 into tank 303, positioned below an opening in trough 36.

The liquid that exits the engine during washing contain water, detergent, and foreign matter. The foreign matter may be in the form of solids and ions dissolved in the water. The matter being released from the engine at a specific wash occasion depends on a number of issues, such as when washing was last conducted, the environment in which the engines operates, etc. Further, the waste liquid may at one wash occasion contain a high amount of solids while at another wash occasion be low on solids. Similarly, the waste liquid may at one wash occasion contain a high amount of ions while at another wash occasion be low on ions. Thus, the waste water treatment system is desirably flexible in its design so that the most appropriate treatment can be conducted at each occasion.

The liquid separation device 31, described above with respect to FIG. 3a, includes a frame enclosing droplet separator profiles. FIG. 3b shows the technique for separating air born droplets with the use of separator profiles. The direction of the air stream is shown by arrows. The droplet separator profiles are arranged in parallel allowing for an air flow through the separator. The droplet separator profiles are arranged standing vertical allowing for liquid on the profile surface to find its way downwards by gravity. FIG. 3b shows a cross section of three droplet separator profiles looking from above and downwards. Droplet separator profile 81 is shaped as shown in FIG. 3b. At about the middle distance from the leading edge to the tail edge of the profile 81, a liquid trap 82 is formed as a pocket for collecting liquid on the surface of profile 81. Droplets 84 are carried with the air stream in between the droplet separator profiles. Inside the separator, the air is deflected as the result of the geometry of profile 81. The air flow deflection is rapid enough to not allow the droplets 84 to follow with the air. The inertia of droplets 84 then allows the droplets 84 to travel un-deflected and impinge on profile 81 at point 83. As liquid continues to build up on the profile surface, a liquid film 85 is formed where the air stream shear forces will carry liquid 85 into liquid trap 82. In liquid trap 82, the liquid will build up and pour downwards by gravity.

With reference to FIG. 4, a water collecting system, according to an embodiment, is illustrated.

The water collecting system, according to an exemplary embodiment, is a type of mobile vehicle, such as a cart 40. The cart 40 has a frame structure 41 and is provided with a water tank 42 for storing water that has been collected during a washing operation. The cart 40 includes a drip pan 43, which is to be positioned beneath the engine to be cleaned so as to collect liquid that exits from the engine at the outlet. Because of the size of an engine and because engines differ in size, there is provided for sliding the drip pan 43 from a retracted position on the cart 40 to a fully extended position in which the drip pan 43 protrudes out from the frame structure 41 by as much as 3 m. The drip pan 43 itself, according to an embodiment, measures 2.5 by 1.5 m (length/width). Suitably the drip pan 43 is releasable from the cart 40 and can be placed on the ground, in cases where the available space beneath the aircraft is too small to accommodate the entire cart 40.

On the cart 40 there is also provided an arm or bar 44 which can be of a fixed length, as shown in the figure, or which can be telescopically extendable (not shown). The arm 44 may be pivotally linked to the frame structure 41 of the cart 40 at a pivot axis 45. The arm 44 can thus be raised from an essentially horizontal position to an upright position by means of e.g. a hydraulically actuated linking arm 46. Of course, other means can be used for moving the arm 44, such as pneumatic, mechanical gear systems, and the like. Actuation may easily be achieved by a foot pump or alternatively by suitable electrical pump means.

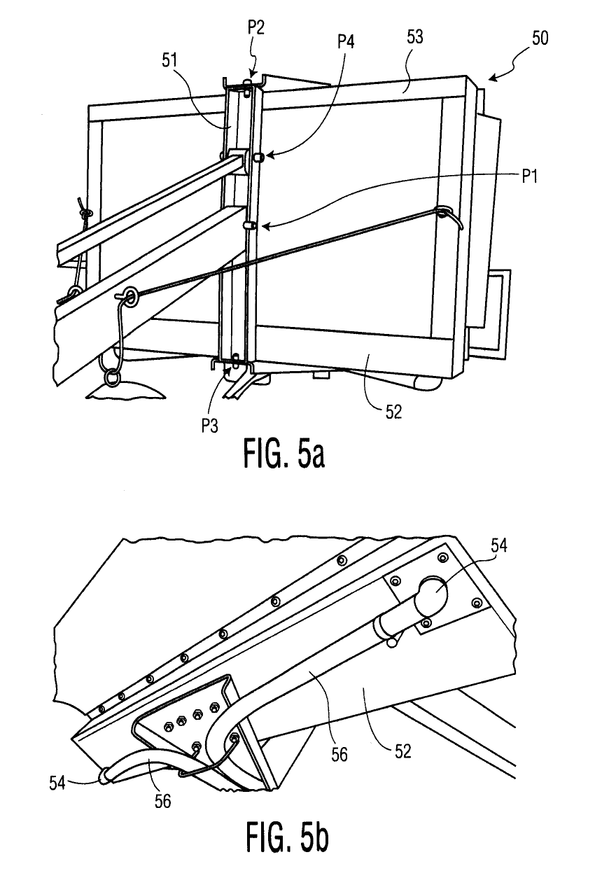

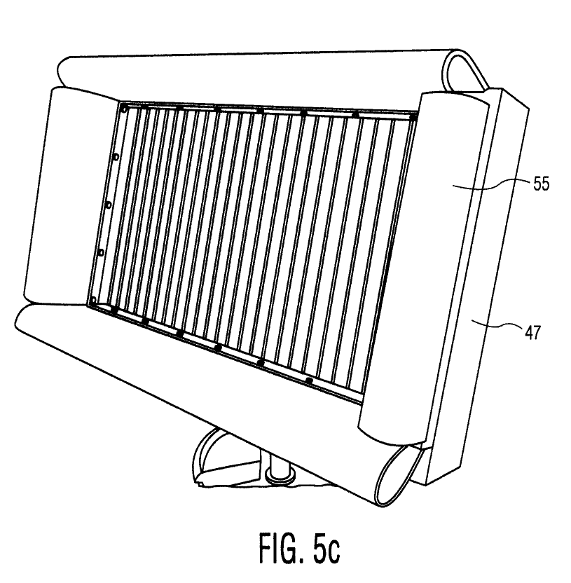

At the other end of the arm 44 is mounted a liquid separation device, which for purposes of illustration and without limitation, according to one exemplary embodiment comprises the operating principles of which have been described in full in the previously mentioned WO 2005/121509. The description is given below with reference to FIGS. 5a, b, and c. In general terms, the liquid separation device 47 comprises a generally rectangular frame 50 housing the active components, referred to in WO 2005/121509 as separator profiles, for separating out droplets from air flowing through the engine that is being subject to a cleaning operation.

In a particular embodiment, shown in FIGS. 5a and b, the frame 50 comprises a lower frame part 52 (shown in detail in FIG. 5b), configured as a hollow container for collecting liquid separated by the liquid separation device 47, and an upper frame part 53. The container is provided with at least one drainage opening 54 for draining liquid from the container to a storage means, suitably located on the mobile cart on which the entire system is mounted. In the embodiment illustrated in FIG. 5b, there are two drainage openings 54 diametrically arranged in the bottom of the lower frame portion 52 at corners thereof. Attached to the drainage openings 54 are tubes, such as flexible tubing 56, for draining the liquid to the storage tank.

As shown in FIG. 5c, the separation device 47 is provided with a collar or flange 55, preferably made of rubber, along the frame parts, on the side facing the aircraft exhaust. The collar 55 is suitably made from rubber tubing or sheet rubber, the latter being shown in FIG. 5c, attached to the frame 50 such that it provides an impact protection. Thus, when the liquid separator frame 50 is brought near the aircraft body, the collar 55, which may preferably be resilient, will prevent the aircraft from being scratched by the frame 50 of the separator 47. Another advantage of incorporating the collar 55 is that it will, at least to some extent, provide a seal against the aircraft in the area around the exhaust, and forms a funnel like structure, such that the liquid to be collected more efficiently is guided into the separator device 47.

With reference again to FIG. 4 and FIG. 5a, the liquid separation device 47 is attached to the arm 44 via a cross-bar 51, extending between the upper frame part 53 of the separator frame 50 and the lower frame part 52. The cross-bar 51 is attached to the support arm 44 in a pivot point P1 at or near the center of the cross-bar 51, thereby allowing the liquid separation device 47 to be turned/rotated around a horizontal axis, i.e. it can be tilted forwards and backwards. The cross-bar 51 is in turn attached to the liquid separation device 47 at two pivot points P2 and P3 respectively, at the upper and lower frame parts 53, 52, respectively, allowing the liquid separation device 47 to be turned around a vertical axis.

Actuation of the cross-bar 51 to move the liquid separation device 47 in the various directions can be by hydraulic means (not shown) or by any other suitable actuating means. Pneumatic systems could be used as well as purely mechanical motor driven gear mechanisms, just to mention a couple of alternatives.

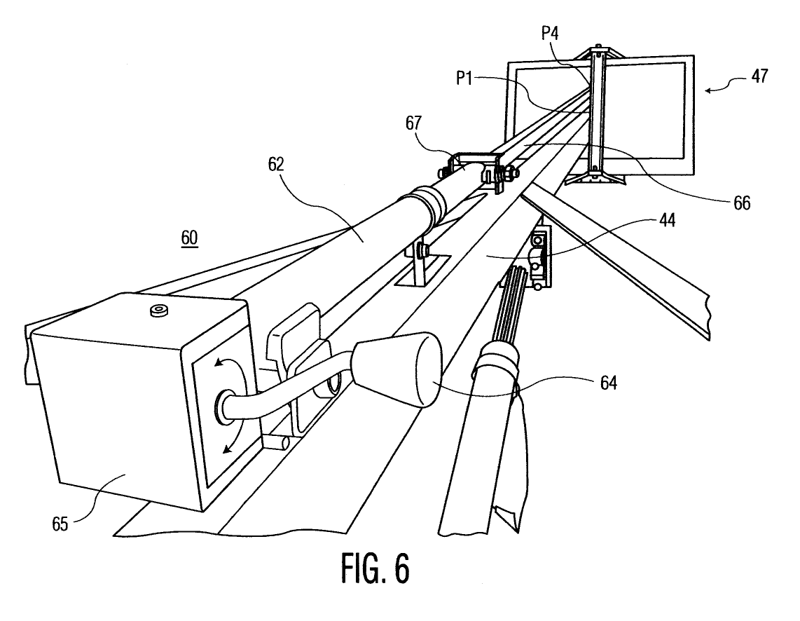

In one embodiment, the manipulation of the liquid separation device 47 in the backwards and forwards direction, referred to as tilting of the device, is achieved by what is herein referred to as a tilting actuator device. Such a device, generally designated 60, in the embodiment shown in FIG. 6, comprises a linear actuator, such as a screw drive. Thereby, a threaded rod (not visible in the figure) is actuated to rotate inside an outer tube 62, by means of a crank 64 coupled to a gear mechanism (inside housing 65), transforming the cranking movement to a rotary movement of the threaded rod. Inside the outer tube 62 there is an inner tube at the lower end of which there is a nut attached, e.g. by welding. The nut is threaded onto the rod, and thus the inner tube, having an outer diameter slightly smaller than the inner diameter of the outer tube 62, will be guided inside the outer tube. At the upper end of the inner tube is an actuating arm 66 linked to the inner tube by a pivot axis 67. Thus, when the threaded rod rotates, the nut on the inner tube will move on the rod in the longitudinal direction, and thus the arm 66 will either push or pull the separator 47 depending on the direction of the rotation. The actuating assembly may be located on the upper side of the support arm 44.

The actuating arm 66 in turn is coupled via a pivot point P4 to the cross-bar 51 on the liquid separation device 47, the pivot point P4 being located off-center on the cross-bar 51 such that when the rod is expelled out of the tube 62 the liquid separation device 47 is tilted forwards, and when the rod is retracted into the tube 62 the liquid separation device 47 is tilted backwards, the entire device pivoting around pivot point P1 (also see FIG. 5a).

The above embodiment is only an example, and as mentioned it can easily be replaced by other types of linear actuator mechanisms.

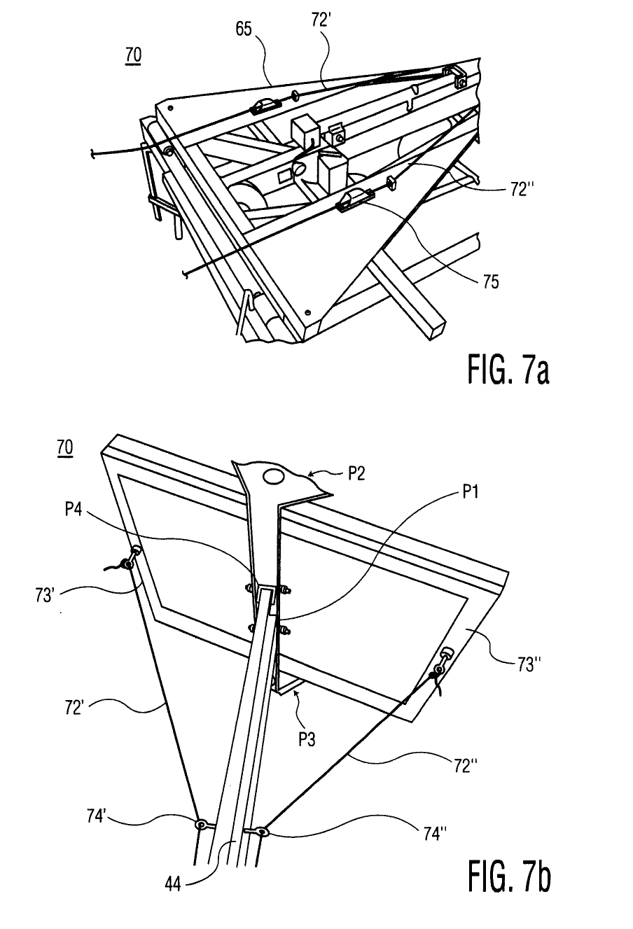

For adjusting the position of the liquid separation device 47 in a sideways direction, i.e. rotating it around an axis perpendicular to the tilting axis (to the right or left, respectively), a mechanism, shown in FIGS. 7a and b, can be used, generally designated 70.

Thus, as shown in FIGS. 7a and b, pulling strings 72′, 72″ are provided on side parts 73′, 73″ of the frame 50 of the liquid separation device 47. The side parts 73′, 73″ connect with the lower and upper frame parts 52, 53, respectively, so as to complete the frame 50.

The strings 72′, 72″ run in guide loops 74′, 74″ provided on the support arm 44 in the upper region thereof, and along the arm all the way down to an operator position at one end of the cart 40. A friction and/or clamping locking device 75 may be provided to secure the strings 72′, 72″ in position so as to lock the liquid separation device 47 in a desired position.

Pulling the right-hand string 72″ will cause the separation device 47 to pivot around the axis defined by pivot points P2 and P3, such that it turns right, to a position indicated in FIG. 7b, and vice versa.

To operate the apparatus for positioning the liquid separation device 47 at, for example, a helicopter exhaust, first the arm 44 is raised by actuating the raising mechanism. When a desired height has been reached, the cart 40 is moved in over the aircraft body to a position in the vicinity of the exhaust. Then the tilting mechanism is used if necessary in conjunction with the mechanism for sideways positioning to set the liquid separation device 47 in a correct position for the collection operation. Thus, the operation can be said to be an iterative procedure, or alternatively, if several movements are performed at the same time, it can be said that the procedure operations are simultaneously performed.

Of course the mechanisms described above are only exemplary embodiments, and many other types of actuating devices and/or mechanisms are possible. Exemplary mechanism could be the provision of a “joy-stick” type device for electrically controlling hydraulic, pneumatic, mechanical or solenoid actuators, acting on the movable components so as to bring about the required positioning of the liquid separator.

By providing this very versatile manipulation possibility, the liquid separation device 47 can be positioned at outlets that have previously been inaccessible, i.e. at or on the aircraft body, preferably forming an angle with the body of 10-60° or more generally of 0-90°.

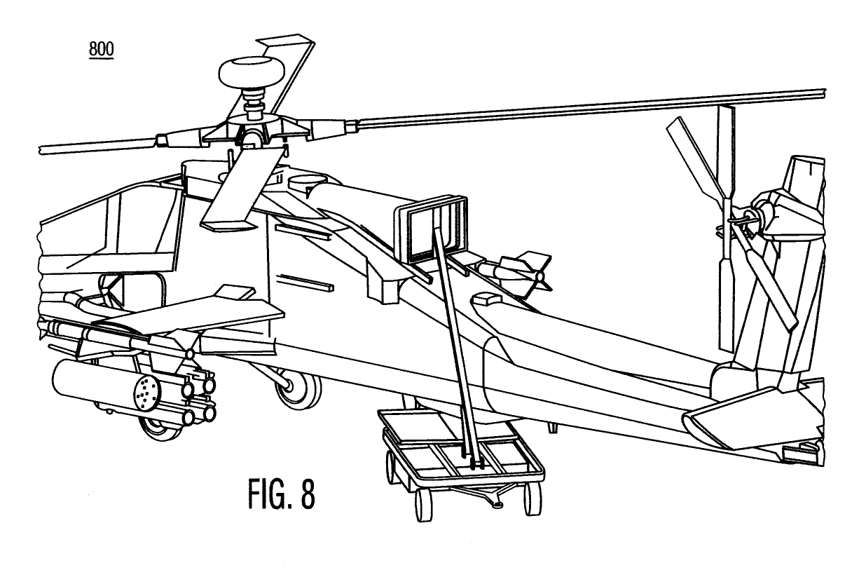

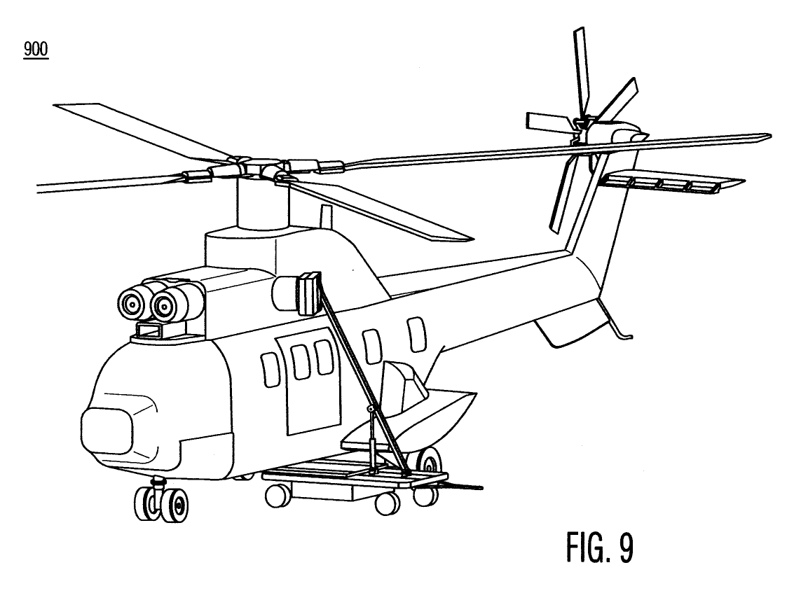

Examples of such applications are for helicopters, which often times have side exhausts located centrally on top of the aircraft body, or where the exhaust is at an angle deviating from perpendicular, as shown in FIGS. 8 and 9 as helicopters 800 and 900.

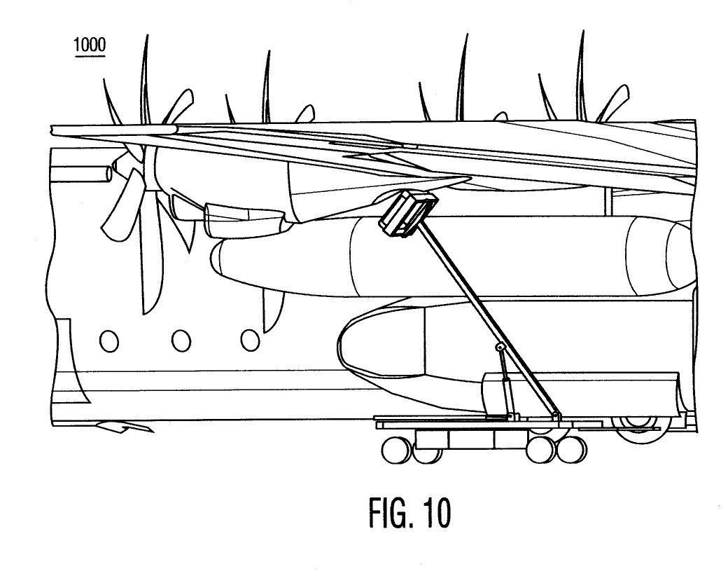

Another example is the C-130 Hercules transport aircraft shown in FIG. 10 as aircraft 1000. This aircraft has rear exhausts on the underside of the wing which renders them inaccessible with previous systems mentioned above.

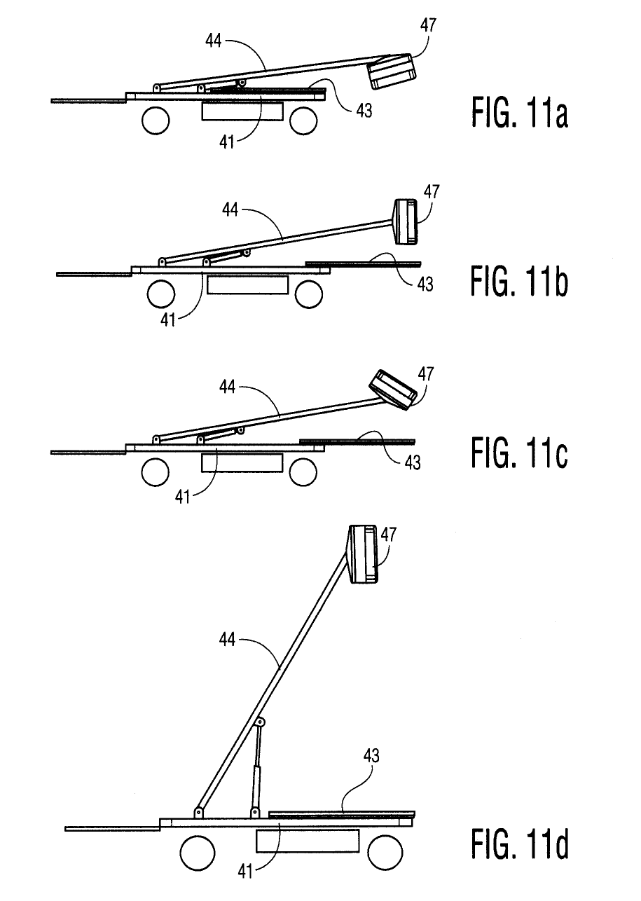

In FIG. 11 two different modes of operation of the water collecting system, according to embodiments, are shown, namely transport mode (FIG. 11a) and service mode (FIGS. 11b-d).

FIG. 11a represents the transport mode, in which the arm 44 has been lowered to an essentially horizontal position and wherein the drip pan 43 has been retracted to rest essentially entirely over the frame 41 of the cart 40. The liquid separation device 47 has been tilted downwards.

FIG. 11b shows the service mode at the minimum or near minimum service height of about 1.2 m, for example. Here the liquid separation device 47 is essentially vertically oriented and the drip pan 43 has been extended to be located beneath the liquid separation device 47.

FIG. 11c represents service at a minimum or near minimum height but wherein the liquid separation device 47 is tilted to adapt to an angled exhaust position.

Finally, FIG. 11d shows the service mode at a fully or near fully extended service height of about 3.7 m, for example, by raising the arm 44 as much or near as much as possible. In this mode, again the drip pan 43 can be retracted. In some cases it will still be extended depending on how the engine outlet is configured, which can vary substantially between aircraft types and models.

The numbers relating to service height are of course only exemplary and it is possible to adapt the design by, for example, providing a telescoping arm for enabling higher service heights.

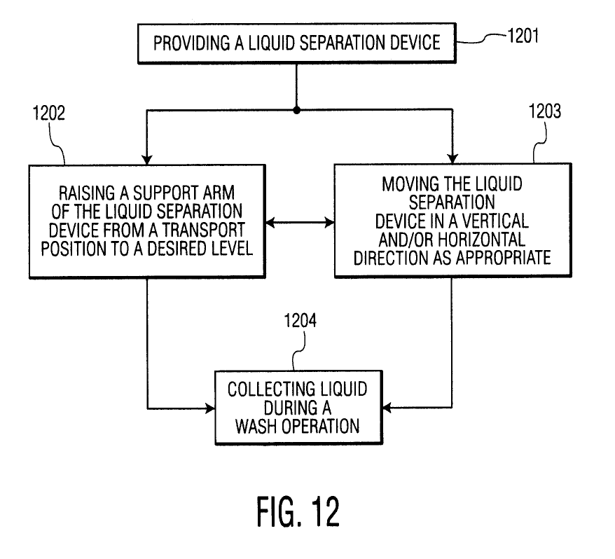

With reference to FIG. 12, a flowchart illustrates a method of collecting liquid emanating from the exhaust of an aircraft turbine engine during a washing operation. The exhaust may be located on the aircraft turbine engine at a position that is not easily accessible.

At 1201, a liquid separation device, such as the liquid separation device 47 described above, is provided. According to an embodiment, the liquid separation device is attached to a support arm and is movable in horizontal and vertical directions about respective pivot points. The support arm is attached to a support structure and may be operable by an actuator device configured to raise and lower the support arm between an essentially horizontal transport position and an operative position.

At 1202, the support arm is raised from the transport position to a level at which the engine subject to cleaning is located. At 1203, the liquid separation device is moved in the horizontal and/or vertical directions. The raising and moving operations at 1202 and 1203, respectively, are implemented to place the liquid separation device in front of the exhaust of the engine. Moreover, the raising and moving operations at 1202 and 1203, respectively, may be performed iteratively and/or simultaneously.

At 1204, liquid is collected during a wash operation with the appropriately placed liquid separation device.

The foregoing examples are provided merely for the purpose of explanation and are in no way to be construed as limiting. While reference to various embodiments are shown, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

1. An apparatus for collecting waste water from cleaning operations performed on aircraft turbine engines, comprising
a frame structure;
a support arm pivotally attached to the frame structure;
an actuator device configured to raise and lower the support arm between an essentially horizontal transport position to an operative position forming an angle in the range from said transport position to said operative position of between 0° and 90° with respect to the horizontal; and
a liquid separation device adapted to be positioned at the exhaust of an aircraft turbine engine, the liquid separation device pivotally attached to the support arm so as to be movable around both a horizontal and a vertical axis.

2. The apparatus as claimed in claim 1, wherein the liquid separation device is mounted to a cross-bar at the end points of said cross-bar in a respective pivot point and wherein said cross-bar is pivotally attached to the support arm in a pivot point at the center of the cross-bar, thereby providing for turning the liquid separation device around said horizontal and vertical axes.

3. The apparatus as claimed in claim 1, wherein said liquid separation device comprises a frame housing active components configured for separating droplets from air flowing through the engine that is being subject to a cleaning operation.

4. The apparatus as claimed in claim 3, wherein the frame comprises a lower frame portion configured as a hollow container for collecting liquid separated by the liquid separation device, said container being provided with at least one drainage opening for draining liquid from the container to a storage means.

5. The apparatus as claimed in claim 4, wherein said container is provided with two drainage openings diametrically arranged in a bottom portion of the container at corners thereof.

6. The apparatus as claimed in claim 1, further comprising
a drip pan on the frame structure configured for collecting waste liquid emanating from the turbine during a cleaning operation; and
a collected waste liquid storage tank provided on said frame structure beneath said drip pan.

7. The apparatus as claimed in claim 6, wherein the drip pan is configured to slide from a position wherein it is located essentially on the frame structure to an extended position wherein it protrudes out from the frame structure.

8. The apparatus as claimed in claim 1, wherein the frame structure is part of a transport cart.

9. The apparatus as claimed in claim 1, wherein the actuator arm is actuated by any of hydraulic, pneumatic, mechanical or electrical means.

10. The apparatus as claimed in claim 1, wherein the liquid separation device comprises liquid separator profiles arranged vertically adjacent each other in a frame of the liquid separation device.

11. The apparatus as claimed in claim 1, further comprising a resilient collar attached to a frame of the liquid separator device.

12. The apparatus as claimed in claim 11, wherein the collar is made of rubber.

13. A method of collecting liquid emanating from the exhaust of an aircraft turbine engine during a washing operation, wherein said exhaust is located on the aircraft turbine engine at a position that is not easily accessible, the method comprising the steps of:
providing a liquid separation device attached to a support arm, said liquid separation device being movable both in a horizontal and a vertical direction about respective pivot points, said support arm being attached to a support structure and operable by an actuator device configured to raise and lower the support arm between an essentially horizontal transport position and an operative position;
at least one of iteratively and simultaneously:
i) raising said support arm from said transport position to a level at which the engine subject to cleaning is located; and
ii) moving the liquid separation device in said horizontal and vertical direction as appropriate,
wherein the raising and moving places the liquid separation device in front of the exhaust of the engine; and
collecting liquid during a wash operation.
